(19) United States
(12) Patent Application Publication
(10) Pub. No.: US 2014/0375228 A1
(43) Pub. Date: Dec. 25, 2014

(54) LIGHTING CONTROL METHOD BY MULTI-TONE MULTI-FREQUENCY SIGNAL AND DEVICE USING THE SAME

(71) Applicant: Yu-Wei Tsai, HsinChu (TW)

(72) Inventor: Yu-Wei Tsai, HsinChu (TW)

(73) Assignee: CHIP GOAL ELECTRONICS CORPORATION, HsinChu (TW)

(21) Appl. No.: 13/924,587

(22) Filed: Jun. 23, 2013

(51) Int. Cl. H05B 37/02

(52) U.S. Cl. CPC H05B 37/02
USPC 315/291

(57) ABSTRACT

The present invention provides a lighting control method by multi-tone multi-frequency signal, which includes: encoding a control signal into a multi-tone multi-frequency signal in a control unit; transmitting the multi-tone multi-frequency signal to a receiving unit; decoding the multi-tone multi-frequency signal to generate a command; and controlling a lighting status of at least one lighting device according to the command. The present invention also provides a device using the aforementioned lighting control method.

### BACKGROUND OF THE INVENTION

1. Field of Invention

The present invention relates to a lighting control method, especially a method of controlling lighting devices by a multi-tone multi-frequency signal. The present invention also provides a lighting control device using the method.

2. Description of Related Art

Lighting devices are usually operated manually. However, when the number of light devices is large (such as in an office building, a public place, or a factory), manual control is disadvantageous because it is very inconvenient and the lighting mode of the lighting devices cannot be programmable in advance. One prior art method controls the lighting devices by a central control system; although this central control system can remotely control the lighting devices and thus manual operation is greatly reduced, the related hardware and maintenance costs are very high. For example, in routine maintenance or to program the lighting mode of the lighting devices, it requires a well-trained engineer to check the cables and set or modify the program, and setting or modifying the program usually requires a special computer; accordingly, the required time, facilities, and technician training in such prior art cause it difficult to be applied for household purpose and its applications are limited.

Another prior art method uses RF signals to control lighting devices. Although this prior art reduces the inconveniences involved by hardware connections, the related facility cost is still very high and therefore its applications are also limited.

In view of the aforementioned problems of the prior art methods, the present invention provides a lighting control method by multi-tone multi-frequency signal and a related device, which has the advantages of low cost, easy setting and easy maintenance.

### SUMMARY OF THE INVENTION

In a perspective of the present invention, alighting control method by multi-tone multi-frequency signal is provided and it includes: encoding a control signal into a multi-tone multi-frequency signal in a control unit; transmitting the multi-tone multi-frequency signal to a receiving unit; decoding the multi-tone multi-frequency signal to generate a command; and controlling a lighting status of at least one lighting device according to the command.

In a preferable embodiment of the present invention, the multi-tone multi-frequency signal is a dual-tone multi-frequency signal.

In a preferable embodiment of the present invention, the lighting control method by multi-tone multi-frequency signal can further include: storing the command.

In a preferable embodiment of the present invention, the step of transmitting the multi-tone multi-frequency signal to the receiving unit or the step of controlling the lighting status of at least one lighting device according to the command is executed at a programmed time point.

In another perspective of the present invention, a lighting control device using multi-tone multi-frequency signal is provided and it includes: a control unit for generating a multi-tone multi-frequency signal; and a lighting unit including at least one lighting device, the lighting unit being for receiving the multi-tone multi-frequency signal and controlling a lighting status of the at least one lighting device according to the multi-tone multi-frequency signal.

In a preferable embodiment of the present invention, the lighting unit further includes: a receiving unit for receiving the multi-tone multi-frequency signal by wired or wireless manner; and a lighting modulation module for controlling the lighting status of the at least one lighting device according to the multi-tone multi-frequency signal.

In a preferable embodiment of the present invention, the lighting modulation module includes: a decoder for decoding the multi-tone multi-frequency signal to generate a digital signal; a processor for generating a lighting control command for controlling the at least one lighting device according to the digital signal; and a lighting controller for controlling the lighting status of the at least one lighting device according to the lighting control command. Optionally, the lighting modulation module can further include a memory unit for storing the digital signal generated by the decoder.

In a preferable embodiment of the present invention, the control unit includes: an input interface for receiving a control signal; an encoder for generating the multi-tone multi-frequency signal by encoding the control signal; and a transmitting unit for transmitting the multi-tone multi-frequency signal. Optionally, the control unit can further include a memory unit for storing the control signal.

In a preferable embodiment of the present invention, the lighting unit is programmable to execute a programmed operation at a programmed time point.

In a preferable embodiment of the present invention, the control unit includes the control unit comprises a loud speaker for transmitting the multi-tone multi-frequency signal and the lighting unit comprises a microphone for receiving the multi-tone multi-frequency signal.

In an embodiment, the multi-tone multi-frequency signal includes one or a combination of a setting command, a control command, and control information.

The objectives, technical details, features, and effects of the present invention will be better understood with regard to the detailed description of the embodiments below, with reference to the drawings.

### BRIEF DESCRIPTION OF THE DRAWINGS

FIG. 1 shows a lighting control device according to the present invention.

FIG. 2 shows a flow chart of the lighting control method according to the present invention.

### DESCRIPTION OF THE PREFERRED EMBODIMENTS

The drawings as referred to throughout the description of the present invention are for illustrative purpose only, but not drawn according to actual scale.

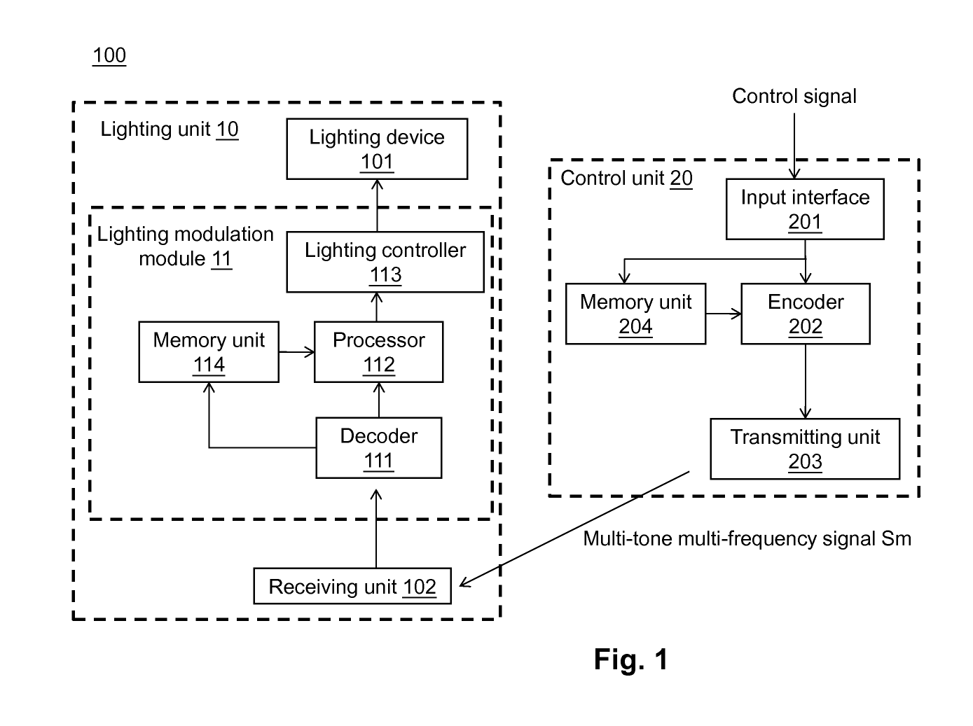

Referring to FIG. 1, which shows a lighting control device 10 according to the present invention. The lighting control device 10 includes a lighting unit 10 and a control unit 20. The control unit 20 generates a multi-tone multi-frequency signal Sm. The lighting unit 10 includes at least one lighting device 101. The lighting unit 10 receives the multi-tone multi-frequency signal and controls the lighting status of the at least one lighting device 101 according to the multi-tone multi-frequency signal Sm. One difference between the present invention and the prior art is that: to control the lighting unit in the prior art, complicated circuits and hardware connections or expensive RF communication facilities are required; however, to control the lighting unit in the present invention, such complicated circuits, hardware connections or expensive RF communication facilities are not required. The present invention can control multiple lighting units 10 by transmitting multiple multi-tone multi-frequency signals Sm simply through air. (Certainly, the multi-tone multi-frequency signals Sm also can be transmitted by wire.) The multi-tone multi-frequency signal Sm for example can be a dual-tone multi-frequency (DTMF) signal such as those used for telephone key tones. However, the present invention is not limited to this example; other types of multi-tone multi-frequency signals such as triple-tone multi-frequency signal are also applicable.

The multi-tone multi-frequency signal generated by the control unit 20 for example includes one or a combination of a setting command, a control command, and control information for the lighting unit 10, and the command or information can be for immediate execution or for a programmed operation to be executed at a predetermined later time point. For example, the setting command can include a basic setting for the lighting unit 10 (such as setting its identification code); the control command can include a command for turning on/off the lighting device 101 of the lighting unit 10; the control information can include one or a combination of the identification code (identifying a designated lighting unit 10 to receive the command), brightness, luminance, color light mixing ratio, and lighting sequence, etc. The lighting unit 10 controls the operation of the lighting device 101 according to the aforementioned control information, for example to adjust the brightness, or to control the lighting unit 10 according to the lighting sequence (e.g., multiple lighting devices 101 having different colors taking turns to illuminate). The control unit 20 can generate the multi-tone multi-frequency signal according to the desired control to be achieved, and send the multi-tone multi-frequency signal to the lighting unit 10.

The lighting unit 10 includes a lighting modulation unit 11, a lighting device 101, and a receiving unit 102. The lighting deice 101 for example can be, but not limited to, a lighting lamp, an atmospheric lighting apparatus, or a display board, etc. The receiving unit 102 can receive the multi-tone multi-frequency signal by wired or wireless manner. In one embodiment, the receiving unit 102 receives the multi-tone multi-frequency signal through air by a wireless manner; the receiving unit 102 for example includes a microphone, and it can further include an amplifier if necessary.

The lighting modulation module 11 controls alighting status of the lighting device 101 according to the multi-tone multi-frequency signal received by receiving unit 10. The lighting modulation module 11 can include an encoder 111, a processor 112, a lighting controller 113, and optionally a memory unit 114. If the lighting unit 10 is only controlled to execute instant operation and it is not required to execute any programmed operation, the memory unit 114 can be omitted. The decoder 111 decodes the multi-tone multi-frequency signal into a digital signal. The processor 112 generates a control command to control the lighting status of the lighting device 101 according to the output from the decoder 111. The lighting controller 113 controls the lighting status of the lighting device 101 according to the control command from the processor 112. The digital signal generated by the decoder 111 can be stored in the memory unit 114 if necessary. The aforementioned configuration is only an illustrative example and can be modified; for example, the decoder 111 and the processor 112 can be merged into one unit, or the processor 112 and the lighting controller 113 can be merged into one unit, etc. As shown in FIG. 1, the control unit 20 includes an input interface 201, an encoder 202, a transmitting unit 203, and a memory unit 204. The input interface 201 receives a control signal and transmits it to the encoder 202. If necessary, the data can be stored in the memory unit 204. If the control unit 20 only performs instant control, the memory unit can be omitted. The input interface 201 can be an interface in any form; for example, the control unit 20 can a handheld device (such as smart phone), and in this case its input interface 201 can be a touchpad of the handheld device. Related software can be stored or downloaded in the handheld device to transform the user's input into a corresponding control signal. The encoder 202 encodes the control signal into the multi-tone multi-frequency signal Sm, and the transmitting unit 203 outputs the multi-tone multi-frequency signal Sm. When the multi-tone multi-frequency signal Sm is transmitted through air, the transmitting unit 203 can include a loud speaker, and can further include an amplifier if necessary. By the above arrangement, the user can control the operation of the lighting unit 10 in a very convenient manner; for example, a security guard on patrol can control the operations of multiple lighting units 10 in a factory by controlling the transmission of the multi-tone multi-frequency signal, and he does not have to control the lighting units 10 one by one. Further, the operations of the lighting units 10 can be programmed; for example, the nightlights can be turned on and other lighting units 10 can be turned off at a predetermined time point. Various other controls of the lighting units 10 can be achieved by means of the present invention.

Besides transmission through air, the control unit 20 can transmit the multi-tone multi-frequency signal Sm to the receiving unit by wire in another embodiment. The multi-tone multi-frequency signal Sm can be transmitted through wire such as by telephone line. Compared with the prior art such as the central control system or the RF signal control, the multi-tone multi-frequency signal transmission according to the present invention is much easier in implementation and costs lower. Furthermore, the hardware infrastructure and maintenance fee of the prior art are very expensive, and the setup and maintenance require trained engineer, which is very inconvenient.

Besides the aforementioned way to activate the multi-tone multi-frequency signal by a user-input control signal, in another embodiment, the control unit 20 can include a programmed operation mode to generate the multi-tone multi-frequency signal SM at a predetermined time point. For example, the control unit 20 can be programmed to execute a night operation mode: at predetermined night time, the night operation mode is turned on, and the control unit 20 automatically transmits a pre-programmed multi-tone multi-frequency signal Sm (for example, by broadcasting system) to multiple target lighting units 10 to control them into a desired lighting status. This arrangement provides a similar benefit as the central control system but is more convenient in operation and costs much less. In other words, the present invention can configure a specific operation mode of the lighting unit 10 in advance; in one embodiment, the specific operation mode can be stored in the control unit 20, and the control unit 20 is programmed to transmit the related multi-tone multi-frequency signal Sm to the lighting unit 10 at the programmed time point. Or in another embodiment, the operation mode can be stored in the lighting unit 10 in advance, and the processor 112 and lighting controller 113 executes the operation (programmed lighting status/statuses of one or more lighting devices) at the programmed time point. In the latter case, no connection is required between the control unit 20 and the lighting unit 10 during the executing operation.

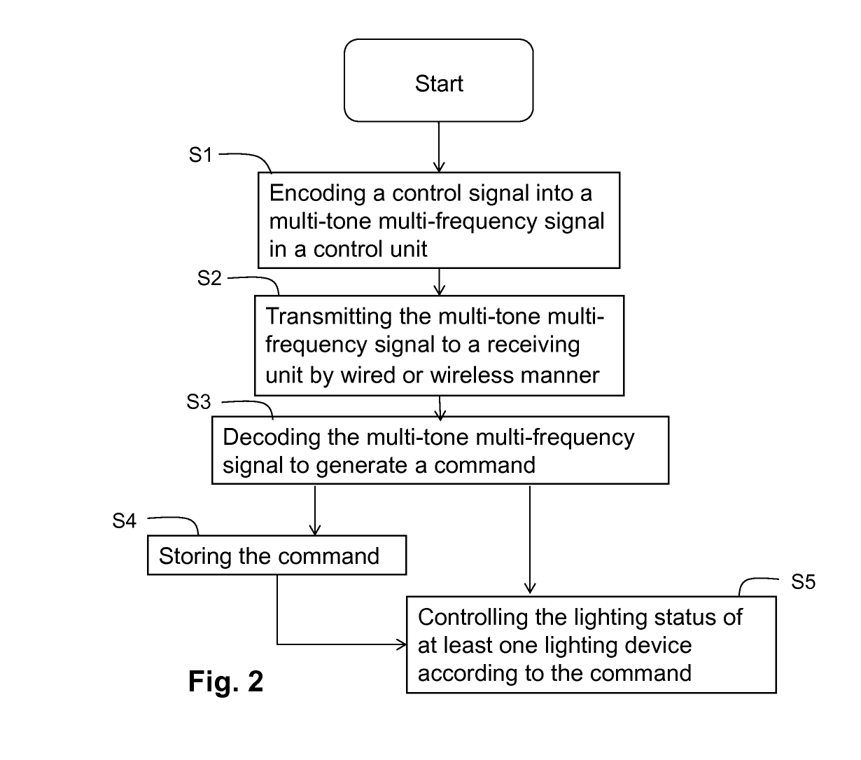

In another perspective of the present invention, referring to FIG. 2, the present invention also provides a lighting control method by multi-tone multi-frequency signal, which includes: encoding a control signal into a multi-tone multi-frequency signal in a control unit (step S1); transmitting the multi-tone multi-frequency signal by wired or wireless manner to a receiving unit (step S2); decoding the multi-tone multi-frequency signal to generate a command (step S3); optionally, storing the command if necessary (step S4); after or in parallel with storing the command, or directly after step S3 if it is not needed to store the command, controlling the lighting status of at least one lighting device according to the command (step S5). The above steps S2 and S5 can be executed at programmed time points if desired.

The present invention has been described in considerable detail with reference to certain preferred embodiments thereof. It should be understood that the description is for illustrative purpose, not for limiting the scope of the present invention. Those skilled in this art can readily conceive variations and modifications within the spirit of the present invention. A circuit or device which does not affect the primary function can be inserted between two units shown to be in direct connection in the figures. An embodiment or a claim of the present invention does not need to attain or include all the objectives, advantages or features described in the above. The abstract and the title are provided for assisting searches and not to be read as limitations to the scope of the present invention.

What is claimed is:

1. A lighting control method by multi-tone multi-frequency signal, comprising:
encoding a control signal into a multi-tone multi-frequency signal in a control unit;
transmitting the multi-tone multi-frequency signal to a receiving unit;
decoding the multi-tone multi-frequency signal to generate a command; and
controlling the lighting status of at least one lighting device according to the command.

2. The lighting control method by multi-tone multi-frequency signal of claim 1, wherein the multi-tone multi-frequency signal is a dual-tone multi-frequency signal.

3. The lighting control method by multi-tone multi-frequency signal of claim 1, further comprising:
storing the command.

4. The lighting control method by multi-tone multi-frequency signal of claim 1, wherein the step of transmitting the multi-tone multi-frequency signal to a receiving unit or the step of controlling the lighting status of at least one lighting device according to the command is executed at a programmed time point.

5. The lighting control method by multi-tone multi-frequency signal of claim 1, wherein the multi-tone multi-frequency signal comprises one or a combination of a setting command, a control command, and control information.

6. A lighting control device using multi-tone multi-frequency signal, comprising:
a control unit for generating a multi-tone multi-frequency signal; and
a lighting unit including at least one lighting device, the lighting unit being for receiving the multi-tone multi-frequency signal and controlling a lighting status of the at least one lighting device according to the multi-tone multi-frequency signal.

7. The lighting control device using multi-tone multi-frequency signal of claim 6, wherein the multi-tone multi-frequency signal is a dual-tone multi-frequency signal.

8. The lighting control device using multi-tone multi-frequency signal of claim 6, wherein the lighting unit further comprises:
a receiving unit for receiving the multi-tone multi-frequency signal by wired or wireless manner; and
a lighting modulation module for controlling the lighting status of the at least one lighting device according to the multi-tone multi-frequency signal.

9. The lighting control device using multi-tone multi-frequency signal of claim 8, wherein the lighting modulation module comprises:
a decoder for decoding the multi-tone multi-frequency signal to generate a digital signal;
a processor for generating a lighting control command for controlling the at least one lighting device according to the digital signal; and
a lighting controller for controlling the lighting status of the at least one lighting device according to the lighting control command.

10. The lighting control device using multi-tone multi-frequency signal of claim 9, wherein the lighting modulation module further comprises:
a memory unit for storing the digital signal generated by the decoder.

11. The lighting control device using multi-tone multi-frequency signal of claim 6, wherein the control unit comprises:
an input interface for receiving a control signal;
an encoder for generating the multi-tone multi-frequency signal by encoding the control signal; and
a transmitting unit for transmitting the multi-tone multi-frequency signal.

12. The lighting control device using multi-tone multi-frequency signal of claim 11, wherein the control unit further comprises:
a memory unit for storing the control signal.

13. The lighting control device using multi-tone multi-frequency signal of claim 6, wherein the lighting unit is programmable to execute a programmed operation.

14. The lighting control device using multi-tone multi-frequency signal of claim 13, wherein the programmed operation is executed at a programmed time point.

15. The lighting control device using multi-tone multi-frequency signal of claim 6, wherein the control unit comprises a loud speaker for transmitting the multi-tone multi-frequency signal and the lighting unit comprises a microphone for receiving the multi-tone multi-frequency signal.

16. The lighting control device using multi-tone multi-frequency signal of claim 6, wherein the multi-tone multi-frequency signal comprises one or a combination of a setting command, a control command, and control information.

17. The lighting control device using multi-tone multi-frequency signal of claim 16, wherein the control information of the lighting unit comprises one or a combination of an identification code, brightness, luminance, color light mixing ratio, and lighting sequence of the lighting unit.
